(19) United States
(12) Patent Application Publication
(10) Pub. No.: US 2023/0047665 A1
(43) Pub. Date: Feb. 16, 2023

(54) METHODS AND SYSTEMS FOR EXPANDING VOCABULARY

(71) Applicant: METIS IP (SUZHOU) LLC, Suzhou (CN)

(72) Inventor: Yan LI, Suzhou (CN)

(73) Assignee: METIS IP (SUZHOU) LLC, Suzhou (CN)

(21) Appl. No.: 17/816,402

(22) Filed: Jul. 30, 2022

(30) Foreign Application Priority Data
Jul. 30, 2021 (CN) 202110869338.0

(51) Int. Cl. G06F 40/289; G06F 40/47

(52) U.S. Cl. CPC G06F 40/289; G06F 40/47; G06F 40/247

(57) ABSTRACT

The present disclosure provides a method and a system for expanding vocabulary. The method includes: obtaining a target vocabulary, the target vocabulary including a single word or a phrase composed of two or more words; obtaining at least one candidate text associated with the target vocabulary; determining a plurality of candidate vocabularies from the at least one candidate text, the plurality of candidate vocabularies including words from the at least one candidate text and a phrase formed by at least two consecutive words in position; and determining at least one expansion vocabulary of the target vocabulary from the plurality of candidate vocabularies.

### CROSS-REFERENCE TO RELATED APPLICATIONS

This application claims priority of Chinese Patent Application No. 202110869338.0, filed on Jul. 30, 2021, the entire contents of which are incorporated herein by reference.

### TECHNICAL FIELD

The present disclosure generally relates to a field of the technology of the text processing, and in particular, to methods and systems for expanding vocabulary.

### BACKGROUND

For some scenarios such as text search and product search based on the vocabulary, most of the relevant texts, products, etc., to be searched cannot be covered and searched only by the target vocabulary input by the user or the obtained target vocabulary. Therefore, the target vocabulary needs to be expanded to obtain the expansion vocabulary of the target vocabulary, so that texts, products, etc., to be searched can be covered more comprehensively and accurately when searched based on the expansion vocabulary.

Therefore, there is an urgent to provide methods and systems for expanding vocabulary to realize the vocabulary expansion of target vocabulary.

### SUMMARY

One of the embodiments of the present disclosure provides a method for expanding vocabulary. The method includes: obtaining a target vocabulary, the target vocabulary including a single word or a phrase composed of two or more words; obtaining at least one candidate text associated with the target vocabulary; determining a plurality of candidate vocabularies from the at least one candidate text, the plurality of candidate vocabularies including words from the at least one candidate text and a phrase formed by at least two consecutive words; and determining at least one expansion vocabulary of the target vocabulary from the plurality of candidate vocabularies.

One of the embodiments of the present disclosure provides a system for expanding vocabulary. The system includes at least one computer-readable storage medium of a set of instructions; and at least one processor in communication with the computer-readable storage medium. When executing the set of instructions, the at least one processor is configured to: obtain a target vocabulary, the target vocabulary including a single word or a phrase composed of two or more words; obtain at least one candidate text associated with the target vocabulary; determine a plurality of candidate vocabularies from the at least one candidate text, the plurality of candidate vocabularies including words from the at least one candidate text and a phrase formed by at least two consecutive words; and determine at least one expansion vocabulary of the target vocabulary from the plurality of candidate vocabularies.

One of the embodiments of the present disclosure provides a non-transitory computer-readable storage medium storing computer instructions. When reading the computer instructions in the storage medium, a computer implements operations including: obtaining a target vocabulary, the target vocabulary including a single word or a phrase composed of two or more words; obtaining at least one candidate text associated with the target vocabulary; determining a plurality of candidate vocabularies from the at least one candidate text, the plurality of candidate vocabularies including words from the at least one candidate text and a phrase formed by at least two consecutive words; and determining at least one expansion vocabulary of the target vocabulary from the plurality of candidate vocabularies.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an application scenario illustrating a system for expanding vocabulary according to some embodiments of the present disclosure;

FIG. 2 is a module diagram illustrating a system for expanding vocabulary according to some embodiments of the present disclosure;

FIG. 3 is an exemplary diagram illustrating a method for expanding vocabulary according to some embodiments of the present disclosure;

FIG. 4 is another exemplary diagram illustrating a method for expanding vocabulary according to some embodiments of the present disclosure; and

FIG. 5 is an exemplary diagram illustrating a target vocabulary, a plurality of candidate vocabularies and expansion vocabulary of target vocabulary according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system”, “engine”, “unit”, “module”, and/or “block” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a”, “an”, and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

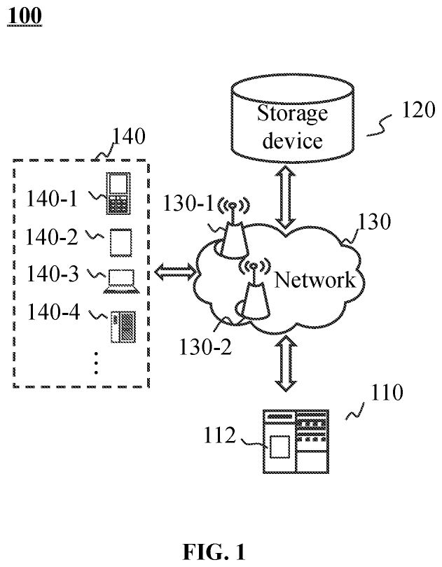

FIG. 1 is a schematic diagram of an application scenario illustrating a system for expanding vocabulary according to some embodiments of the present disclosure.

An application scenario 100 may involve various scenarios in which vocabulary expansion may be performed. For example, a search vocabulary entered by the user is expanded to find related texts, and a term is expanded to find related products, and the like.

By expanding the vocabulary, more expansion vocabularies may be obtained, so that more comprehensive and accurate related texts, products, etc., may be covered when searched based on the expansion vocabularies. In some embodiments, a target vocabulary for vocabulary expansion may be a word or a phrase composed of at least two words. As for the vocabulary expansion of the target vocabulary, it is hoped that not only may the vocabulary be expanded to obtain the expansion vocabularies, but also expansion phrases may be obtained to cover more and wider related expansion vocabularies. And for a phrase composed of at least two words, it is also desirable to perform accurate vocabulary expansion to obtain an expansion vocabulary of the phrase (such as a word and/or a phrase composed of at least two words).

In view of the above situation, some embodiments of the present disclosure provide a method and system for expanding vocabulary, by acquiring at least one candidate text associated with a target vocabulary, and using a word and a phrase composed of at least two consecutive words in the candidate text as candidate vocabularies, to obtain a plurality of candidate vocabularies. Thus, a more complete and richer set of candidate vocabularies that include phrases in addition to words can be obtained. Then, expansion vocabularies (including expansion words and phrases) that are more accurate and with wider coverage may be determined from the candidate vocabularies, thereby achieving accurate and wide-coverage vocabulary expansion for both words and phrases.

As shown in FIG. 1, the application scenario 100 of the system for vocabulary expansion may include a server 110, a processing device 112, a storage device 120, a network 130 and a user terminal 140.

The server 110 may be used to manage resources and process data and/or information from at least one component of the system or external data sources (e.g., cloud data centers). The server 110 may execute program instructions based on such data, information and/or processing results to perform one or more of the functions described in the present disclosure. In some embodiments, the server 110 may be a single server or a server group. The server group may be centralized or distributed (e.g., the server 110 may be a distributed system), dedicated or concurrently provided by other devices or systems. In some embodiments, the server 110 may be regional or remote. In some embodiments, the server 110 may be implemented on a cloud platform, or provided in a virtual fashion. Merely by way of example, the cloud platform may include a private cloud, a public cloud, a hybrid cloud, a community cloud, a distributed cloud, an internal cloud, a multi-layer cloud, etc., or any combination thereof.

The processing device 112 may process data and/or information obtained from other devices or components of the system. The processor may execute program instructions based on such data, information and/or processing results to perform one or more of the functions described in the present disclosure. In some embodiments, the processing device 112 may include one or more sub-processing devices (e.g., a single-core processing device or a multi-core processing device). Merely by way of example, the processing device 112 may include a central processing unit (CPU), an application specific integrated circuit (ASIC), an application specific instruction processor (ASIP), a graphics processor unit (GPU), a physical processor unit (PPU), a digital signal processor (DSP), a field programmable gate array (FPGA), programmable logic device (PLD), a controller, a microcontroller unit, a reduced instruction set computer (RISC), a microprocessor, etc., or any combination thereof.

The storage device 120 may be used to store data and/or instructions. The storage device 120 may include one or more storage components, and each storage component may be an independent device or a part of other devices. In some embodiments, the storage device 120 may include a random access memory (RAM), a read only memory (ROM), a mass storage, a removable memory, a volatile read-write memory, or the like, or any combination thereof. Illustratively, the mass storage may include a magnetic disk, an optical disk, a solid state disk, and the like. In some embodiments, the storage device 120 may be implemented on the cloud platform.

Data refers to a digital representation of information, and may include various types, such as binary data, text data, image data, video data, and the like. Instructions are programs that control a device or apparatus to perform a specific function.

The user terminal 140 refers to one or more terminal devices or software used by the user. In some embodiments, the user terminal 140 may be used by any user, such as an individual, a business, or the like. In some embodiments, the user terminal 140 may be one of a mobile device 140-1, tablet computer 140-2, a laptop computer 140-3, a desktop computer 140-4, etc., and other devices with input and/or output capabilities or any combination thereof. The above examples are only used to illustrate the breadth choice of the user terminal 140 and not to limit the scope thereof.

In some embodiments, the storage device 120 may be included in the server 110, the user terminal 140, and possibly other system components.

In some embodiments, the processing device 112 may be included in the server 110, the user terminal 140, and other possible system components.

The network 130 may connect components of the system and/or connect portions of the system with external resources. The network 130 enables communication between the various components, as well as with other components outside the system, facilitating the exchange of data and/or information. In some embodiments, the network 130 may be any one or more of a wired network or a wireless network. For example, the network 130 may include a cable network, a fiber optic network, a telecommunications network, the Internet, a local area network (LAN), a wide area network (WAN), a wireless local area network (WLAN), a metropolitan area network (MAN), a public switched telephone network (PSTN), a BLUETOOTH® network, a ZIGBEE® network, a near field communication (NFC), an in-device bus, an in-device line, a cable connection, etc., or any combination thereof. The network connection between the various parts may be in one of the above-mentioned ways, and may also be in a variety of ways. In some embodiments, the network may be in point-to-point, shared, centralized, etc., various topologies or a combination of multiple topologies. In some embodiments, the network 130 may include one or more network access points. For example, the network 130 may include wired or wireless network access points, such as base stations and/or network switching points 130-1, 130-2, ..., through which one or more components of system 200 may connect to the network 130 to exchange data and/or information.

The server 110 may communicate with the processing device 112, the storage device 120, and the user terminal 140 through the network 130 to obtain data and/or information, such as obtaining a target vocabulary from the user terminal 140 through the network 130, and obtaining a text library from the storage device 120 through the network 130 to obtain a candidate text, etc. The server 110 may execute program instructions based on the acquired data, information and/or processing results to implement vocabulary expansion of the target vocabulary. For example, the server 110 may obtain one or more candidate texts associated with the target vocabulary based on the obtained target vocabulary, text library, and determine a plurality of candidate vocabularies from the one or more candidate texts, and determine at least one expansion vocabulary of the target vocabulary from a plurality of candidate vocabularies. The storage device 120 may store the text library and various data and/or information in the steps of the method for expanding vocabulary, such as the text library, candidate text, expansion vocabulary, and the like. The user terminal 140 may provide the target vocabulary, for example, through user input to obtain the target vocabulary. The information passing relationship between the above devices is only an example, and the present disclosure is not limited thereto.

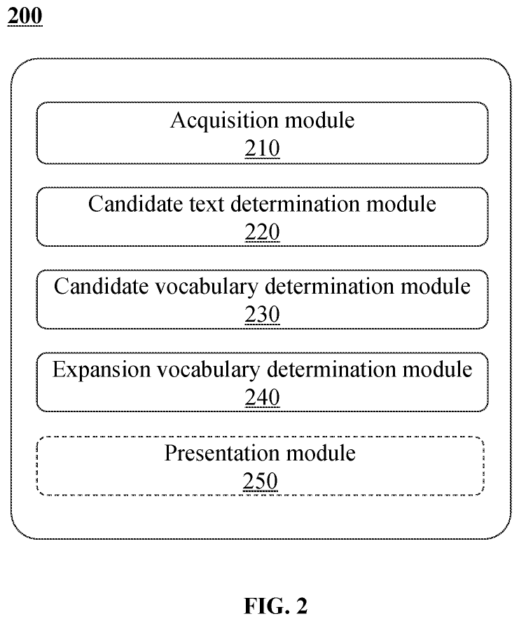

FIG. 2 is a module diagram illustrating a system for expanding vocabulary according to some embodiments of the present disclosure.

In some embodiments, a vocabulary expansion system 200 (also referred to as system for expanding vocabulary) may be implemented on the processing device 112. The vocabulary expansion system 200 may include an acquisition module 210, a candidate text determination module 220, a candidate vocabulary determination module 230 and an expansion vocabulary determination module 240. In some embodiments, the vocabulary expansion system 200 may also include a presentation module 250.

In some embodiments, the acquisition module 210 may be configured to obtain a target vocabulary, and the target vocabulary may include a single word or a phrase composed of two or more words. In some embodiments, the acquisition module 210 may be used to obtain the base word as the target vocabulary. In some embodiments, the expansion vocabulary determination module 240 may also be used to obtain a translation result of the base vocabulary, and use the translation result as the target vocabulary, where the base vocabulary may include a single word or a phrase composed of two or more words.

In some embodiments, the candidate text determination module 220 may be configured to obtain at least one candidate text associated with the target vocabulary. In some embodiments, the candidate text determination module 220 may be configured to determine a text retrieval condition, and obtain the at least one candidate text that satisfies the text retrieval condition and is associated with the target vocabulary by performing retrieval in a text database based on the text retrieval condition and the target vocabulary.

In some embodiments, the candidate vocabulary determination module 230 may be configured to determine a plurality of candidate vocabularies from one or more candidate texts, and the candidate vocabularies may include words and a phrase formed by at least two consecutive words in the one or more candidate texts.

In some embodiments, the expansion vocabulary determination module 240 may be used to determine one or more expansion vocabularies of the target vocabulary from the plurality of candidate vocabularies.

In some embodiments, the expansion vocabulary determination module 240 may be further configured to determine the similarity between the target vocabulary and the plurality of candidate vocabularies, and use the candidate vocabularies whose similarity satisfies a preset condition as the expansion vocabulary.

In some embodiments, the expansion vocabulary determination module 240 may also be configured to obtain a first sentence including the target vocabulary, and may also obtain a first sentence vector representation corresponding to the first sentence; replace the target vocabulary in the first sentence with a plurality of candidate vocabularies to obtain a plurality of second sentences, and may also obtain a plurality of vector representations of the second sentences corresponding to a plurality of second sentences; may determine the similarity between a plurality of second sentences and the first sentence based on a plurality of second sentence vector representations and the first sentence vector representation, and then determine that the candidate vocabularies in the second sentence whose similarity satisfies the preset condition as the expansion vocabularies.

In some embodiments, the expansion vocabulary determination module 240 may also be used to determine a synonym of the expansion vocabulary or a unit synonym of the word included in the expansion vocabulary; and determine a combined phrase of the synonyms or the unit synonyms of different words as the expansion vocabulary of the target vocabulary.

In some embodiments, the expansion vocabulary determination module 240 may also be configured to obtain one or more translation results of one or more expansion vocabularies, and determine the one or more translation results as the expansion vocabularies of the target vocabulary.

In some embodiments, the presentation module 250 may be used to present the at least one expansion vocabulary and an origin of the expansion vocabulary.

It should be understood that the illustrated system and its modules may be implemented in a variety of ways. For example, in some embodiments, the system and its modules may be implemented in hardware, software, or a combination of software and hardware. The hardware part may be realized by using dedicated logic; the software part may be stored in a memory and executed by a suitable instruction execution system, such as a microprocessor or specially designed hardware. Those skilled in the art may understand that the methods and systems described above may be implemented using computer-executable instructions and/or embodied in a processor control code, for example on a carrier medium such as a disk, CD or DVD-ROM, a programmable memory such as a read only memory (firmware), or a data carrier such as an optical or electronic signal carrier, such a code is provided. The system and its modules of the present disclosure may be implemented not only by hardware circuits such as very large scale integrated circuits or gate arrays, semiconductors such as logic chips, transistors, etc., or programmable hardware devices such as field programmable gate arrays, programmable logic devices, etc., may also be implemented by software executed by various types of processors, for example, or by a combination of the above-mentioned hardware circuits and software (e.g., firmware).

It should be noted that the above description of the system and its modules is only for the convenience of description, and does not limit the description to the scope of the embodiments. It can be understood that for those skilled in the art, after understanding the principle of the system, various modules may be combined arbitrarily, or a sub-system may be formed to connect with other modules without departing from the principle.

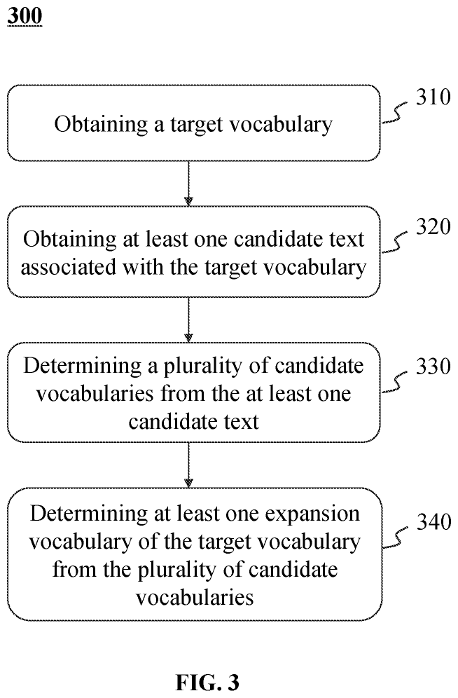

FIG. 3 is an exemplary diagram illustrating a method for expanding vocabulary according to some embodiments of the present disclosure.

In some embodiments, a method 300 may be performed by the processing device 112. In some embodiments, the method 300 may be implemented by the vocabulary expansion system 200 deployed on the processing device 112.

As shown in FIG. 3, the method 300 may include the following steps.

Step 310, obtaining a target vocabulary.

In some embodiments, step 310 may be performed by the acquisition module 210.

The target vocabulary refers to the vocabulary to be expanded.

In some embodiments, the target vocabulary may include a single word. The words may be words of various language categories, such as words in Chinese, English and the like. For example, the target vocabulary may include the words such as “ [symbol] ”, “ [symbol] ”, “dispensing”, and the like.

In some embodiments, the target vocabulary may include a phrase composed of two or more words. For example, the target vocabulary may include the phrases “ [symbol] , [symbol] ”, “ [symbol] ”, “dispensing equipment”, etc., where “ [symbol] ” is a phrase composed of the words “ [symbol] ”and “ [symbol] ”, “ [symbol] ” is a phrase composed of “ [symbol] ” and “ [symbol] ”, and “dispensing equipment” is a phrase composed of “dispensing” and “equipment”.

In some embodiments, the acquisition module 210 may obtain vocabularies (such as words or phrases), through various methods such as user input, text content extraction, and character recognition, to obtain the target vocabularies.

In some embodiments, the vocabularies obtained by the acquisition module 210 may be referred to as base vocabularies.

In some embodiments, an acquired base vocabulary may be used as the target vocabulary, for example, the user inputs the phrase “ [symbol] ”, that is, the base vocabulary, and directly uses “ [symbol] ” as the target vocabulary.

In some embodiments, the acquisition module 210 may obtain a translation result corresponding to the base vocabulary in various language categories, and use the translation result of the base vocabulary as the target vocabulary. For example, if the user inputs the word “, [symbol] ”, which is the base vocabulary, and the translation result of “ [symbol] ” in English is “dispenser”, then “dispenser” may be used as the target vocabulary. For another example, the user inputs the phrase “ [symbol] ”, which is the base vocabulary, and the translation result of “ [symbol] ” in English is “dispensing device”, then “dispensing device” may be used as the target vocabulary.

In some embodiments, the acquisition module 210 may obtain the translation result of the target vocabulary by invoking a translation program, querying a translation vocabulary table and the like.

In some embodiments, the user may confirm the translation result of the target vocabulary, and if the confirmed translation result is inaccurate or does not meet requirements, the user may correct it to obtain an accurate or required translation result.

In some embodiments, by using the translation result of the base vocabulary as the target vocabulary, the base vocabulary may be expanded in more language categories, so that the vocabulary expansion covers a wider range of language categories, and thus has a wider application range.

In some embodiments, the target vocabulary may include one or more word meanings.

In some embodiments, the processing device may obtain one or more word meanings of the target vocabulary. For example, one or more word meanings of the target vocabulary may be obtained by querying through various feasible methods. The processing device may determine a target vocabulary meaning in one or more word meanings of the target vocabulary, and the target vocabulary meaning may be a word meaning that conforms to the user's interest. For example, the target vocabulary meaning may be determined based on a user's selection of one or more word meanings.

In some embodiments, the processing device may obtain the target vocabulary meaning through user input.

In some embodiments, the processing device may obtain the text corresponding to the target vocabulary meaning, that is, a text of the target vocabulary meaning.

Step 320, obtaining at least one candidate text associated with the target vocabulary.

In some embodiments, step 320 may be performed by the candidate text determination module 220.

In the present disclosure, the text associated with the target vocabulary may be referred to the candidate text.

In some embodiments, the candidate text determination module 220 may retrieve one or more texts associated with the target vocabulary in a text library based on the target vocabulary, and use the one or more texts as the candidate text. The association with the target vocabulary may refer to, for example, including the target vocabulary, or being the same or similar to a subject of the target vocabulary. For example, if the target vocabulary is “ [symbol] ”, search the text database based on “ [symbol] ” to obtain a candidate text 1 and a candidate text 2 including the word “ [symbol] ” in the text, or obtain a candidate text 3 and a candidate text 4 with the text subject “ [symbol] ”. It should be noted that the above examples are only examples, not limitations.

In some embodiments, the target vocabulary may include the base vocabulary and a translation result of the base vocabulary, the plurality of determined candidate texts may include one or more texts associated with the base vocabulary, and may also include one or more texts associated with the translation result of the base vocabulary.

In some embodiments, the text retrieval condition may be determined for obtaining one or more candidate texts by performing retrieval in the text database based on the text retrieval condition and the target vocabulary.

The text retrieval condition refers to the condition that the text and retrieval process need to meet during the text retrieval, such as a category of the text, a relevant time of the text, a field of the text, and a range of the text content to be retrieved. As an example, when searching a patent text in a patent text database, the retrieval condition may include a classification number of the patent, a relevant term of the patent, a patentee, a scope of the search in the patent text, etc., in which the search scope may include claims, abstract, etc., of the patent text.

In some embodiments, the text retrieval condition may be set according to actual needs or set according to experience, the embodiment does not limit here.

In some embodiments, the candidate text determination module 220 may perform retrieval in the text database based on the text retrieval condition (also referred to as text search condition) and the target vocabulary, obtain one or more texts that satisfy the text retrieval condition and are associated with the target vocabulary, and determine the retrieved one or more texts as candidate texts. For example, when retrieving patent texts in the patent text database, the text search condition is that the scope of the patent text search is the claims and the description, while the target vocabulary is “ [symbol] ”, by searching in the patent text library based on the determined text search condition and the target vocabulary “ [symbol] ”, and the candidate text 3 and the candidate text 4 that contain “ [symbol] ” in the claims may be obtained.

In some embodiments, the target vocabulary may include the base vocabulary and the translation results of the base vocabulary in various language categories, and the plurality of determined candidate texts may include one or more texts that satisfy the text retrieval condition and are associated with the base vocabulary, and may also include one or more texts that satisfy the text retrieval condition and are associated with the translation results of the base vocabulary in various language categories.

It may be understood that, in some embodiments, the plurality of determined candidate texts may include texts in a plurality of language categories. In some embodiments, the ratio of the amount of candidate texts among the plurality of candidate texts in different language categories (e.g., Chinese, English) satisfies a preset condition. The preset condition may be set according to actual requirements or experience. For example, the preset condition is that the ratio of the amount of Chinese candidate texts to the amount of English candidate texts is greater than 1.5.

In some embodiments, the candidate text determination module 220 may obtain other more texts related to the retrieved candidate texts based on one or more candidate texts obtained by performing retrieval, and may also determine the obtained other more texts as candidate texts. Being related to the candidate text may refer to one or more of the following: the subject matter of a text is the same or similar to that of the candidate text, the text is mentioned or cited by the candidate text, and the like. It should be noted that the above examples are only examples, not limitations. Through this embodiment, more candidate texts that may include expansion vocabularies corresponding to the target vocabularies may be obtained, so that the coverage of the candidate texts is wider and more complete.

In some embodiments, the candidate text determination module 220 may determine an extension vocabulary through an extension model based on the candidate text, and determine an extension text based on the extension vocabulary. The extension text refers to the text, obtained based on the candidate texts, associated with the target vocabulary. The candidate text determination module 220 may also use the obtained extension text as the candidate text.

The extension vocabulary refers to the text associated with a masked text in the candidate text. Mask refers to masking some words or phrases in the candidate text. Mask information may be represented by a mask position vector or other means. The elements in the mask position vector represent a position of the masked text within the candidate text. Exemplarily, the masked position vector (56, 57) indicates that the masked text is the text (e.g., a word or a phrase) composed of the 56th and 57th characters in the candidate text. In some embodiments, the masked text may be the base vocabulary or phrase. In some embodiments, the masked text may be the target vocabulary or phrase. In some embodiments, the masked words or masked phrases may be determined by user input.

The extension model refers to the model used to determine the extension vocabulary. In some embodiments, the extension model may include a natural language processing model trained by a corpus (e.g., a patent text corpus), such as a Bidirectional Encoder Representation from Transformers (BERT) model, A Lite BERT(ALBERT) model, etc., trained by the patent text corpus.

The input of the extension model may include the candidate text and the masked position vector, and the output of the extension model may include the extension vocabulary or phrase at the mask corresponding to the masked position vector, and a confidence coefficient. The confidence coefficient refers to the reliability of the predicted results. In some embodiments, the confidence coefficient may be the probability that the extension vocabulary or phrase appears in the location of the mask.

In some embodiments, the candidate text determination module 220 may determine the extension text based on the extension vocabulary or phrase and the confidence coefficient. In some embodiments, if the confidence coefficient is greater than a preset threshold, the extension text may be determined based on the extension vocabulary or phrase. For example, the patent text containing the extension vocabulary or phrase in the abstract may be searched, and the above search result may be used as the extension text. In some embodiments, at least one extension vocabulary or phrase may be sorted in descending order according to the corresponding confidence coefficient, and the extension text may be determined by performing retrieval based on the top N extension vocabularies or phrases whose confidence coefficients are greater than a preset threshold.

In some embodiments, the candidate text determination module 220 may train the extension model with a plurality of labeled training samples. For example, a plurality of labeled training samples may be input into the extension model, a loss function may be constructed based on the labels and the processing results of the extension model, and the parameters of the extension model may be iteratively updated through gradient descent or other methods based on the loss function. When the preset conditions are met, the model training is completed, and the trained extension model is obtained. The preset conditions may be that the loss function converges, the amount of iterations reaches a threshold, and the like. In some embodiments, the training samples may include patent text annotated with mask locations. Labels may represent words or phrases that are filled in where the mask is located. Labels may be obtained based on a manual annotation.

Based on the extension model to determine the extension vocabularies or phrases and the confidence coefficients, the vocabularies or phrases that are filled in the mask may be predicted through a semantic correlation between the texts, which reduces the omission caused by the different expressions of vocabularies with the same meaning, thereby the obtained candidate text is richer and more accurate.

In some embodiments, the processing device may screen the obtained plurality of candidate texts based on the target vocabulary meaning. In some embodiments, the processing device may obtain a sentence in the candidate text in which the target vocabulary is located (may be referred to as a target vocabulary sentence). The processing device may replace the target vocabulary in the target vocabulary sentence with the text of the target vocabulary meaning to obtain a replacement sentence corresponding to the target vocabulary sentence. The processing device may acquire the similarity (which may be referred to as a sentence similarity) between the target vocabulary sentence and the corresponding replacement sentence. For a candidate text, the processing device may determine whether to discard the candidate text based on the sentence similarity between each target vocabulary sentence in the candidate text and the corresponding replacement sentence. For example, for a candidate text, the processing device may determine whether the sum of the sentence similarities of all target vocabulary sentences and the corresponding replacement sentences in the candidate text satisfies a preset condition (e.g., the sum of the sentence similarities is less than a preset threshold, the ranking of the sum of the sentence similarities in the plurality of candidate texts is a preset ranking, etc.), if satisfied, the candidate text may be determined to be discarded.

By screening the obtained candidate texts based on the target vocabulary meaning, the candidate texts that do not meet the user's interests may be screened out and discarded, so that the vocabulary meanings of the candidate vocabularies or expansion vocabularies determined from the candidate texts are more accurate, and in line with user's interests. The processing efficiency of subsequent processes can also be improved by discarding candidate texts that do not meet user's interests.

Step 330, determining a plurality of candidate vocabularies from the at least one candidate text.

In some embodiments, step 330 may be performed by the candidate vocabulary determination module 230.

In some embodiments, the candidate vocabulary refers to the word that is a candidate for the expansion vocabulary of the target vocabulary.

In some embodiments, the candidate vocabulary determination module 230 may determine a plurality of candidate vocabularies, such as 20, 30, etc., from one or more candidate texts.

In some embodiments, the candidate vocabulary determination module 230 may perform word segmentation on the obtained candidate text to obtain words included in the candidate text, and obtain a plurality of candidate vocabularies based on the words included in the candidate text.

In some embodiments, the candidate vocabulary determination module 230 may use words included in the candidate text as candidate vocabularies. For example, to obtain the words “ [symbol] ”, “ [symbol] ”, “ [symbol] ”, “ [symbol] ”, “ [symbol] ” from the segmented candidate text, then “ [symbol] ”, “ [symbol] ”, “ [symbol] ”, “ [symbol] ”, “ [symbol] ” may be candidate vocabularies.

In some embodiments, the candidate vocabulary determination module 230 may further use a phrase composed by at least two consecutive words in the candidate text as the candidate vocabulary. The at least two consecutive words may be two words, three words, etc., whose positions are continuous. For example, if a word sequence {“ [symbol] ”, “ [symbol] ”, “ [symbol] ”} is obtained by segmenting the candidate text, the phrases “ [symbol] ”, “ [symbol] ”, “ [symbol] ” may be used as candidate vocabularies. It should be noted that the above examples are only examples, not limitations.

In some embodiments, the candidate vocabulary determination module 230 may also translate the candidate vocabulary into a vocabulary in other types of languages, and then convert the vocabulary in other types of languages into a vocabulary in the original type of language, which may be added to the candidate vocabulary. For example, the candidate vocabulary “ [symbol] ” may be translated into Japanese “ [symbol] ”, then the Japanese “ [symbol] ” may be translated back into Chinese “ [symbol] ”, and “ [symbol] ” may be added to the candidate vocabulary.

In some embodiments, the candidate vocabulary determination module 230 may determine the language into which the candidate vocabulary is to be translated based on the language distribution of a related document of the candidate vocabulary.

The related document refers to document associated with candidate vocabularies. In some embodiments, the related document may include document obtained by performing the patent search based on candidate vocabulary and the document cited.

Language distribution refers to the distribution of the written languages of a certain type of document. Language distribution may be represented by a language distribution vector or other means. The elements in the language distribution vector represent an amount (or a proportion) of a language that occurs in related documents. Taking a three-dimensional language distribution vector composed of three languages, Chinese, Japanese and English and represented by amount as an example, in the related document of the candidate vocabulary “dispenser”, there are articles a written in Chinese, articles b written in Japanese, and articles c written in English, then the language distribution vector of the candidate vocabulary “dispenser” is (a, b, c). In some embodiments, a language in the language distribution vector that is greater than a threshold and is not the same language as that of the candidate vocabulary may be determined as the language into which the candidate vocabulary is to be translated.

In some embodiments, by traversing the words in the candidate text, all the words in the candidate text and multiple phrases composed by at least two consecutive words in the candidate text are used as candidate vocabularies, and a plurality candidate vocabularies are obtained. The words and phrases in the candidate text are used as candidates for expansion vocabulary, so as to achieve a more complete and richer vocabulary of candidate vocabulary sets. In addition, the words and phrases in the candidate text are determined as candidates for expansion vocabulary, so that the candidate vocabularies may include words and phrases that do not necessarily exist in the dictionary or are commonly used, and the candidate vocabularies may include artificially fabricated words in the candidate text, and uncommon terms and phrases used in a small amount of literature and in a specific field, which makes the coverage of candidate vocabularies wider.

Step 340, determining at least one expansion vocabulary of the target vocabulary from the plurality of candidate vocabularies.

In some embodiments, step 340 may be performed by the expansion vocabulary determination module 240.

The expansion vocabulary refers to the vocabulary obtained by expanding the target vocabulary.

In some embodiments, the expansion vocabulary determination module 240 may determine the candidate vocabulary among the plurality of candidate vocabularies that meets a preset requirement as the expansion vocabulary. The preset requirement may include one or more of the following: the similarity between the candidate vocabulary and the target vocabulary satisfies the preset condition, and the similarity between the second sentence and the first sentence where the candidate vocabulary is located satisfies the preset condition.

In some embodiments, the expansion vocabulary determination module 240 may determine one or more candidate vocabularies that are semantically similar or matched with the target vocabulary from the plurality of candidate vocabularies, and use them as one or more expansion vocabularies of the target vocabulary.

In some embodiments, the expansion vocabulary determination module 240 may determine the similarity between the target vocabulary and a plurality of candidate vocabularies, and use the candidate vocabulary whose similarity satisfies the preset condition as the expansion vocabulary of the target vocabulary.

The preset condition may be various conditions that need to be satisfied by the similarity between the candidate vocabulary and the target vocabulary. For example, the preset condition may be that the similarity is greater than a threshold such as 80%. For another example, the preset condition may be that the similarity ranking is Top N, and N is a positive integer, such as 4, 5, and so on. It should be noted that the above examples are only examples, not limitations.

In some embodiments, the expansion vocabulary determination module 240 may obtain a vector representation of the target vocabulary and multiple vector representations corresponding to multiple candidate vocabularies. In the present disclosure, the vector representation of the target vocabulary may be referred to as a first vocabulary vector representation, and the vector representation of the candidate vocabulary may be referred to as a second vocabulary vector representation.

In some embodiments, the first vocabulary vector representation of the target vocabulary and the second vocabulary vector representation of the candidate vocabulary may be obtained based on text encoding methods such as a one-hot encoding method, a n-gram encoding method, a tf-idf-based encoding method, a word2vecto algorithm, etc.

In some embodiments, the first vocabulary vector representation of the target vocabulary and the second vocabulary vector representation of the candidate vocabulary may be obtained based on a natural language processing model. In some embodiments, the natural language processing model may include BERT, RNN, NNLM, CNN, RCNN models, and the like. Taking the BERT model as an example, the target vocabulary may be input into the BERT model, the BERT model learns through representation, and outputs the first vocabulary vector representation of the target vocabulary, and multiple candidate vocabularies may be input into the BERT model respectively, and the BERT model learns through representation, and outputs a plurality of the second vocabulary vector representations of the plurality of candidate vocabularies.

In some embodiments, the expansion vocabulary determination module 240 may determine the similarity between the plurality of candidate vocabularies and the target vocabulary based on the plurality of the second vocabulary vector representations and the first vocabulary vector representation.

In some embodiments, vector distances between a plurality of the second vocabulary vector representations and the first vocabulary vector representation may be calculated, and the similarity between the candidate vocabular and the target vocabulary may be determined based on the vector distances. The vector distance may include a cosine distance, a Euclidean distance, or a Hamming distance, etc.

Based on the similarity of the target vocabulary and multiple candidate vocabularies, the candidate vocabulary whose similarity satisfies the preset condition is used as the expansion vocabulary of the target vocabulary, and the candidate vocabulary with the same or similar semantics as the target vocabulary may also be used as the expansion vocabulary, thereby obtaining the accurate vocabulary expansion result.

In some embodiments, the expansion vocabulary determination module 240 may obtain sentences that include the target vocabulary. In the present disclosure, a sentence including a target vocabulary may be referred to as a first sentence. For example, if the target vocabulary is “ [symbol] ”, a sentence including “ [symbol] ”, such as “ [symbol] [symbol] [symbol] [symbol] [symbol] ”, may be obtained as the first sentence.

In some embodiments, the expansion vocabulary determination module 240 may obtain the first sentence based on the target vocabulary meaning, so that the vocabulary meaning of the target vocabulary in the first sentence matches the target vocabulary meaning.

In some embodiments, the first sentence may be obtained through user input, text content extraction, character recognition, etc., which is not limited in this embodiment.

In some embodiments, the expansion vocabulary determination module 240 may replace the target vocabulary in the first sentence with a plurality of candidate vocabularies, respectively, to obtain a plurality of second sentences. The second sentence refers to a sentence obtained by replacing the target vocabulary in the first sentence with a candidate vocabulary. As an example, continuing to take the aforementioned first sentence as an example, the candidate vocabularies include “ [symbol] [symbol] ”,“ [symbol] ”, “ [symbol] ”, etc. Replacing the “ [symbol] ” in the first sentence “ [symbol] [symbol] [symbol] [symbol] [symbol] ” with “ [symbol] ”, the second sentence “ [symbol] [symbol] [symbol] [symbol] [symbol] ” may be obtained. Similarly, for other candidate vocabularies, the corresponding second sentence may also be obtained by the above method.

In some embodiments, the similarity between a plurality of second sentences and the first sentence may be determined, and the candidate vocabularies in the second sentences whose similarity satisfy the preset condition are used as expansion vocabularies.

In some embodiments, the expansion vocabulary determination module 240 may obtain the vector representation of the first sentence and a plurality of vector representations corresponding to a plurality of second sentences. In the present disclosure, the vector representation of the first sentence may be referred to as the first sentence vector representation, and the vector representation of the second sentence may be referred to as the second sentence vector representation.

In some embodiments, the first sentence vector representation of the first sentence and the second sentence vector representation of the second sentence may be obtained based on text encoding methods such as the one-hot encoding method, a n-gram encoding method, a tf-idf-based encoding method, word2vecto algorithm, etc.

In some embodiments, the expansion vocabulary determination module 240 may obtain the first sentence vector representation of the first sentence and the second sentence vector representation of the second sentence based on the natural language processing model. In some embodiments, the natural language processing model may include BERT, RNN, NNLM, CNN, RCNN models, and the like. The acquisition of the first sentence vector representation of the first sentence and the second sentence vector representation of the second sentence based on the natural language processing model may be similar to the acquisition of the first vocabulary vector representation of the target vocabulary and second vocabulary the vector representation of the candidate vocabulary based on the natural language processing model. For more details, please refer to step 340 in FIG. 3 and its related description.

In some embodiments, the expansion vocabulary determination module 240 may determine the similarity between the plurality of second sentences and the first sentence based on the plurality of second sentence vector representations and the first sentence vector representation. The determination of the similarity between the plurality of second sentences and the first sentence may be similar to the determination of the similarity between the target vocabulary and the plurality of candidate vocabularies. For more details, refer to step 340 in FIG. 3 and its related description.

In some embodiments, the expansion vocabulary determination module 240 may, based on the similarity between the plurality of second sentences and the first sentence, use candidate vocabulary in the second sentence whose similarity satisfies the preset condition as the expansion vocabulary of the target vocabulary. The preset condition may be various conditions that need to be satisfied by the similarity between the candidate vocabulary and the target vocabulary. For example, the preset condition may be that the similarity is greater than a threshold such as 80%. For another example, the preset condition may be that the similarity ranking is Top N, and N is a positive integer, such as 4, 5, and so on. It should be noted that the above examples are only examples, not limitations.

By the similarity based on a plurality of second sentences and the first sentence, the candidate vocabulary in the second sentence whose similarity satisfies the preset condition is used as the expansion vocabulary of the target vocabulary. It considers a situation that when the candidate vocabulary and the target vocabulary are in the same sentence, the determined expansion vocabulary and the target vocabulary are in the same sentence in combination with the semantics of the sentence context, the obtained sentence has the same or similar semantics, thereby avoiding the situation that only the semantics of the vocabularies themselves are the same or similar, but the semantics of the two vocabularies combined with the context in the sentence may deviate greatly. Thus, the accuracy of the determined expansion vocabularies is further guaranteed.

In some embodiments, the preset condition that the similarity between the candidate vocabulary and the target vocabulary satisfies, and the preset condition that the second sentence and the first sentence need to satisfy may be determined based on the amount of the determined candidate texts. In some embodiments, if it is determined that a large amount of candidate texts is obtained, the preset condition such as a similarity threshold may be larger, and if it is determined that a smaller amount of candidate texts is obtained, the preset condition such as the similarity threshold may be less than the similarity threshold when the amount of candidate texts is large.

In some embodiments, the expansion vocabulary determination module 240 may determine the similarity of the target vocabulary meaning to the target vocabulary. The preset condition satisfied by the candidate vocabulary may include that the similarity between the candidate vocabulary and the target vocabulary meaning meets a requirement (e.g., the similarity between the candidate vocabulary and the target vocabulary meaning is greater than the preset threshold, the ranking of the similarity between the candidate vocabulary and the target vocabulary meaning among the plurality of candidate vocabularies is the preset ranking, etc.).

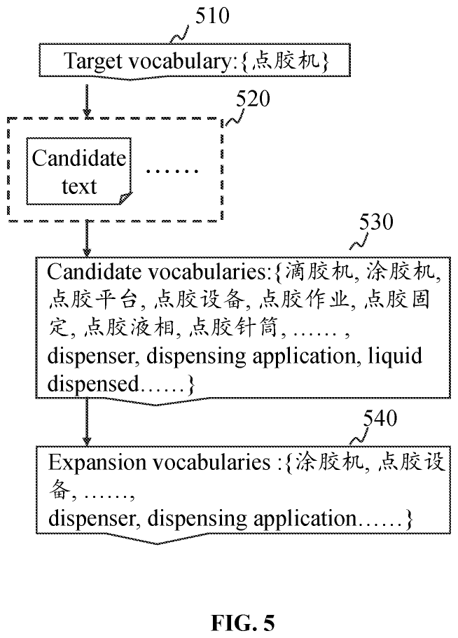

FIG. 5 is an exemplary diagram illustrating a target vocabulary, a plurality of candidate vocabularies and expansion vocabulary of target vocabulary according to some embodiments of the present disclosure. As shown in FIG. 5 , the acquisition module 210 obtains the target vocabulary 510 “ [symbol] ”; the candidate vocabulary determination module 220 obtains a plurality of candidate texts 520 based on the retrieval of the target vocabulary “ [symbol] ”; the candidate vocabulary determination module 230 obtains a plurality of candidate vocabularies 530 from a plurality of candidate texts, and the plurality of candidate vocabularies 530 include: “ [symbol] ”, “ [symbol] [symbol] ”,“ [symbol] ”, “ [symbol] ”, “ [symbol] ”, “ [symbol] ”, “ [symbol] ”, “ [symbol] ”, “dispenser”, “dispensing application”, “liquid dispensed”, etc.; the expansion vocabulary determination module 240 determines a plurality of expansion vocabularies 540 of the target vocabulary “ [symbol] ” from the plurality of candidate vocabularies, and the expansion vocabularies 540 may include: “ [symbol] ”, “ [symbol] ”, “dispenser”, “dispensing application” etc.

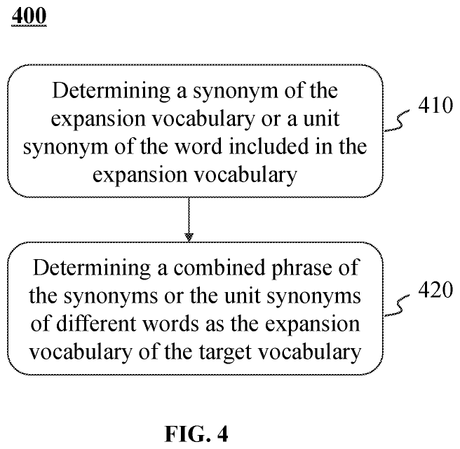

In some embodiments, vocabulary expansion may be performed based on the determined expansion vocabularies to obtain more expansion vocabularies. For more vocabulary expansion methods, please refer to FIG. 4 and its related descriptions.

In some embodiments, the expansion vocabulary determination module 240 may obtain one or more translation results of one or more expansion vocabularies, and determine the one or more translation results as expansion vocabularies of the target vocabulary. For example, the expansion vocabulary “ [symbol] ” of the target vocabulary “ [symbol] ” corresponds to the translation result in English as “dispensing equipment”, then “dispensing equipment” may be used as the expansion vocabulary for “ [symbol] ”. Through this embodiment, expansion vocabularies covering more language categories may be obtained, so that the language categories covered by the vocabulary expansion are wider, and thus the application scope is wider.

In some embodiments, the expansion vocabulary determination module 240 may obtain the translation result of the expansion vocabulary by invoking the translation program, querying the translation vocabulary table, or the like.

In some embodiments, the user may confirm the translation result of the expansion vocabulary. If the confirmed translation result is inaccurate or does not meet the needs, the user may correct it to obtain the accurate or necessary translation result.

In some embodiments, the presentation module 250 may present the one or more determined expansion vocabularies and the origin of the expansion vocabularies, in which the origin of the expansion vocabularies may include information of the candidate text, such as the text title, text number, etc., of the candidate text.

In some embodiments, the presentation module 250 may present the origin of the expansion vocabulary in conjunction with the web page. For example, the source of the expansion vocabulary, that is, the candidate text, the sentence including the expansion vocabulary, the patent number corresponding to the candidate text where the expansion vocabulary is located, etc., may be viewed through the web page.

By presenting the expansion vocabularies and the origin of the expansion vocabularies, users may understand the expansion vocabularies and the origin of the expansion vocabularies more intuitively, and users may select the desired and more suitable expansion vocabularies in a more targeted manner, which helps to improve the user experience and the application effect of the expansion vocabularies.

FIG. 4 is another exemplary diagram illustrating a method for expanding vocabulary according to some embodiments of the present disclosure.

In some embodiments, a method 400 may be performed by the processing device 112. In some embodiments, the method 400 may be implemented by the vocabulary expansion system 200 deployed on the processing device 112.

As shown in FIG. 4, the method 400 may include the following steps.

Step 410, determining a synonym of the expansion vocabulary or a unit synonym of the word included in the expansion vocabulary.

In some embodiments, step 410 may be performed by the expansion vocabulary determination module 240.

Synonym is a word that is semantically the same or similar to a word. The synonym of the expansion vocabulary is a word that has the same or similar meaning as the expansion vocabulary. For example, one expansion vocabulary of the target vocabulary “ [symbol] ,” is “ [symbol] ”, and the synonyms of “ [symbol] ” may include “ [symbol] ”, “ [symbol] ”, and so on. For another example, an expansion vocabulary of the target vocabulary “ [symbol] ,” is “spray dispensing device”, and the synonyms of “spray dispensing device” may include “aerosol dispensing device”, “spray dispensing arrangement”, and the like.

In some embodiments, the expansion vocabulary is a phrase composed of two or more words, and the synonyms of the words included in the phrase may be called the unit synonym. For example, an expansion vocabulary of the target vocabulary “ [symbol] ” is “ [symbol] ”, and the included words are “ [symbol] ” and “ [symbol] ”, and the unit synonyms of the word “ [symbol] ” included in the expansion vocabulary may include “ [symbol] ”, “ [symbol] ”; the unit synonyms of the word “ [symbol] ” included in the expansion vocabulary may include “ [symbol] [symbol] ”, “ [symbol] ”.

In some embodiments, the expansion vocabulary determination module 240 may determine synonyms by searching for words with the same or similar semantics as synonyms in the vocabulary, generating words or synonyms of words through natural language models (such as BERT, LSTM, etc.) and other methods. Generating the word or the synonym of the word through the natural language model may be realized by training the natural language model based on word samples, and the trained natural language model may obtain a corresponding synonym based on the word or vocabulary.

Step 420, determining a combined phrase of the synonyms or the unit synonyms of different words as the expansion vocabulary of the target vocabulary.

In some embodiments, step 420 may be performed by the expansion vocabulary determination module 240.

In some embodiments, the expansion vocabulary determination module 240 may also determine the synonym of the expansion vocabulary as the expansion vocabulary of the target vocabulary. For example, the synonyms “ [symbol] ”, “ [symbol] ” of the expansion vocabulary “ [symbol] ” are also determined as expansion vocabularies of the target vocabulary “ [symbol] ”.

In some embodiments, for the expansion vocabulary composed of two or more words, the expansion vocabulary determination module 240 may also determine the combined phrase of unit synonyms of different words in the expansion vocabulary as the expansion vocabulary of the target vocabulary. The combined phrases of unit synonyms of different words in the expansion vocabulary may be any combination of unit synonyms of different words. For example, the expansion vocabulary “ [symbol] ” includes the two words “ [symbol] ”, “ [symbol] ”, the unit synonyms of “ [symbol] ” include “ [symbol] ” and “ [symbol] ”, and the unit synonyms of “ [symbol] ” include “ [symbol] ” and “ [symbol] ”, the two unit synonyms “ [symbol] ”, “ [symbol] ” and the two unit synonyms “ [symbol] ”, “ [symbol] ” may be combined arbitrarily, and four kinds of combined words “ [symbol] ”, “ [symbol] ”, “ [symbol] ”, “ [symbol] ” may be obtained, and these four combined words may be determined as the expansion vocabularies of the target vocabulary “ [symbol] ”. Similarly, if the expansion vocabulary includes 3 words, and each word includes 2 unit synonyms, the unit synonyms of the 3 words may be combined arbitrarily to obtain the combined phrases composed of 3 unit synonyms, and 3 unit synonyms are derived from the unit synonyms of 3 words respectively. By analogy, for the expansion vocabulary including multiple words (such as 4, etc.), the combined phrase may be composed of the unit synonyms of the word in a similar way, and the combined phrase is also determined as the expansion vocabulary of the target vocabulary. It should be noted that the above examples are only examples, not limitations.

In some embodiments, the expansion vocabulary determination module 240 may determine the similarity of the combined phrase to the target vocabulary meaning. The expansion vocabulary determination module 240 may determine the combined phrase whose similarity with the target vocabulary meaning satisfies a requirement (e.g., the similarity between the combined phrase and the target vocabulary meaning is greater than the preset threshold, the ranking of the similarity between the combined phrase and the target vocabulary meaning in multiple combined phrases is the preset ranking, etc.) among the multiple combined phrases as the expansion vocabulary of the target vocabulary.

By determining the synonym of the word as the expansion vocabulary of the target vocabulary, and also determining the combined phrase of the unit synonyms of different words in the expansion vocabulary as the expansion vocabulary of the target vocabulary, the expansion vocabulary can be further expanded to obtain more abundant expansion vocabularies with similar semantics, thus further increasing the coverage of the expansion vocabulary. In addition, when rich and accurate expansion vocabularies are not obtained from multiple candidate vocabularies in the candidate text, more accurate expansion vocabulary may be obtained by further expanding a small amount of expansion vocabularies, avoiding the situation where the accurate or desired expansion vocabulary cannot be obtained from multiple candidate vocabularies in the candidate text.

It should be noted that the above description about the process 300 and the process 400 is only for illustration and description, and does not limit the scope of application of the present disclosure. For those skilled in the art, various modifications and changes may be made to the process 300 and the process 400 under the guidance of the present disclosure. However, these corrections and changes are still within the scope of the present disclosure. For example, in the process 300, while acquiring the target vocabulary, the target vocabulary may be determined as the candidate vocabulary. For another example, in the process 400, determining the synonym of the expansion vocabulary firstly, determining the synonym as the expansion vocabulary of the target vocabulary, then determining the unit synonym of the word included in the expanded vocabulary, and determining the combination of the unit synonyms of different words as the expansion vocabulary of the target vocabulary.

Embodiments of the present disclosure further provide a device for expanding vocabulary, including at least one storage medium and at least one processor, where the at least one storage medium is configured to store the computer instructions; the at least one processor is configured to execute the computer instructions to implement the vocabulary expansion method. The method includes: obtaining a target vocabulary, the target vocabulary including a single word or a phrase composed of two or more words; obtaining at least one candidate text associated with the target vocabulary; determining a plurality of candidate vocabularies from the at least one candidate text, the plurality of candidate vocabularies including words from the at least one candidate text and a phrase formed by at least two consecutive words; and determining at least one expansion vocabulary of the target vocabulary from the plurality of candidate vocabularies.

The beneficial effects that the embodiments of the present disclosure bring include, but are not limited to the following description. (1) By obtaining at least one candidate text associated with the target vocabulary, words in the candidate text and the phrase composed of at least two consecutive words are used as the candidate vocabulary, multiple candidate vocabularies are obtained. It is possible to obtain a more complete candidate vocabulary set with more abundant vocabularies including phrases in addition to words, and to achieve accurate and broader vocabulary expansion for both words and phrases. In addition, the candidate vocabularies may include words and phrases that do not necessarily exist in the dictionary or are commonly used, and the candidate vocabularies may include artificially fabricated words in the candidate text, and uncommon terms and phrases used in a small amount of literature and in a specific field, which makes the coverage of candidate vocabularies wider, thus more accurate and broader expansion vocabularies can be determined from the candidate vocabularies. (2) Based on the similarity of the target vocabulary and multiple candidate vocabularies, the candidate vocabulary whose similarity satisfies the preset condition is used as the expansion vocabulary of the target vocabulary, and the candidate vocabulary with the same or similar semantics as the target vocabulary may be used as the expansion vocabulary, thereby obtaining the accurate vocabulary expansion result. (3) By obtaining the translation result of the base vocabulary, using the translation result as the target vocabulary and obtaining the translation result of the extension vocabulary, and using the translation result as the expansion vocabulary of the target vocabulary, the expansion vocabulary of the target vocabulary in multiple language categories such as Chinese, English, Japanese etc., can be obtained according to the different needs of users, which makes it suitable for a wider application range. It should be noted that different embodiments may have different beneficial effects, and in different embodiments, the possible beneficial effects may be any one or a combination of the above, or any other possible beneficial effects.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment”, “an embodiment”, and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit”, “module”, or “system”. Furthermore, aspects of the present disclosure may take the form of a computer program product embodied in one or more computer readable media having computer-readable program code embodied thereon.

A computer storage medium may contain a propagated data signal with the computer program code embodied therein, for example, on baseband or as part of a carrier wave. The propagated signal may take a variety of manifestations, including electromagnetic, optical, etc., or a suitable combination thereof. The computer storage media may be any computer-readable medium other than computer-readable storage medium that can communicate, propagate, or transmit a program for use by coupling to an instruction execution system, apparatus, or device. Program code on a computer storage medium may be transmitted using any suitable medium, including radio, cable, fiber optic cable, RF, or the like, or a combination thereof.

The computer program code required for the operation of the various parts of the present disclosure may be written in any one or more programming languages, including object-oriented programming languages such as Java, Scala, Smalltalk, Eiffel, JADE, Emerald, C++, C#, VB.NET, Python etc., conventional procedural programming languages such as C language, Visual Basic, Fortran2003, Perl, COBOL2002, PHP, ABAP, dynamic programming languages such as Python, Ruby and Groovy, or other programming languages, etc. The program code may run entirely on the user's computer, or as a standalone software package on the user's computer, or partly on the user's computer and partly on a remote computer, or entirely on the remote computer or processing device. In the latter case, the remote computer can be connected to the user's computer through any network, such as a local area network (LAN) or wide area network (WAN), or to an external computer (e.g., through the Internet), or in a cloud computing environment, or as a service such as Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for expanding a vocabulary, comprising:
obtaining a target vocabulary, the target vocabulary including a single word or a phrase composed of two or more words;
obtaining at least one candidate text associated with the target vocabulary;
determining a plurality of candidate vocabularies from the at least one candidate text, the plurality of candidate vocabularies including words from the at least one candidate text and a phrase formed by at least two consecutive words; and
determining at least one expansion vocabulary of the target vocabulary from the plurality of candidate vocabularies.

2. The method of claim 1, wherein the obtaining at least one candidate text associated with the target vocabulary comprises:
determining a text retrieval condition; and
obtaining the at least one candidate text that satisfies the text retrieval condition and is associated with the target vocabulary by performing retrieval in a text database based on the text retrieval condition and the target vocabulary.

3. The method of claim 1, wherein the determining at least one expansion vocabulary of the target vocabulary from the plurality of candidate vocabularies comprises:
determining a candidate vocabulary that satisfies a preset requirement from the plurality of candidate vocabularies, and using the candidate vocabulary that satisfies the preset requirement as the expansion vocabulary; wherein the preset requirement includes that a similarity between the target vocabulary and the candidate vocabulary satisfies a preset condition.

4. The method of claim 1, further comprising:
obtaining at least one translation result of the at least one expansion vocabulary, and determining the at least one translation result as the expansion vocabulary of the target vocabulary.

5. The method of claim 1, wherein the obtaining a target vocabulary comprises:
obtaining a base vocabulary as the target vocabulary; or
obtaining a translation result of the base vocabulary, and using the translation result as the target vocabulary; wherein
the base vocabulary includes a single word or a phrase composed of two or more words.

6. The method of claim 1, further comprising:
presenting the at least one expansion vocabulary and an origin of the expansion vocabulary.

7. A system for expanding vocabulary, comprising at least one computer-readable storage medium of a set of instructions; and
at least one processor in communication with the computer-readable storage medium, wherein when executing the set of instructions, the at least one processor is configured to:
obtain a target vocabulary, the target vocabulary including a single word or a phrase composed of two or more words;
obtain at least one candidate text associated with the target vocabulary;
determine a plurality of candidate vocabularies from the at least one candidate text, the plurality of candidate vocabularies including words from the at least one candidate text and a phrase formed by at least two consecutive words; and
determine at least one expansion vocabulary of the target vocabulary from the plurality of candidate vocabularies.

8. The system of claim 7, wherein the at least one processor is configured to: determine a candidate vocabulary that satisfies a preset requirement from the plurality of candidate vocabularies, and use the candidate vocabulary that satisfies the preset requirement as the expansion vocabulary; wherein the preset requirement includes that a similarity between the target vocabulary and the candidate vocabulary satisfies a preset condition.

9. The system of claim 7, wherein the at least one processor is further configured to: obtain at least one translation result of the at least one expansion vocabulary, and determine the at least one translation result as the expansion vocabulary of the target vocabulary.

10. The system of claim 7, wherein the at least one processor is further configured to:
obtain a base vocabulary as the target vocabulary; or
obtain a translation result of the base vocabulary, and use the translation result as the target vocabulary; wherein
the base vocabulary includes a single word or a phrase composed of two or more words.

11. The system of claim 7, wherein the at least one processor is configured to:
present the at least one expansion vocabulary and an origin of the expansion vocabulary.

12. A non-transitory computer-readable storage medium storing computer instructions, wherein when reading the computer instructions in the storage medium, a computer implements operations comprising:
obtaining a target vocabulary, the target vocabulary including a single word or a phrase composed of two or more words;
obtaining at least one candidate text associated with the target vocabulary;
determining a plurality of candidate vocabularies from the at least one candidate text, the plurality of candidate vocabularies including words from the at least one candidate text and a phrase formed by at least two consecutive words in position; and
determining at least one expansion vocabulary of the target vocabulary from the plurality of candidate vocabularies.
